(19) United States
(12) Patent Application Publication
(10) Pub. No.: US 2021/0257823 A1
(43) Pub. Date: Aug. 19, 2021

(54) WATERPROOF STRUCTURE FOR MULTICORE WIRE

(71) Applicant: Sumitomo Wiring Systems, Ltd., Yokkaichi-shi, Mie (JP)

(72) Inventors: Kyungwoo Kim, Yokkaichi-shi, Mie (JP); Toshinari Kobayashi, Yokkaichi-shi, Mie (JP); Moriyuki Shimizu, Yokkaichi-shi, Mie (JP); Koichi Kato, Yokkaichi-shi, Mie (JP)

(21) Appl. No.: 17/251,880

(22) PCT Filed: May 30, 2019
(86) PCT No.: PCT/JP2019/021504

§ 371 Date: Dec. 14, 2020

(30) Foreign Application Priority Data
Jun. 15, 2018 (JP) 2018-114157

(51) Int. Cl. H02G 15/04; H01B 7/02; H01R 13/52

(52) U.S. Cl. CPC H02G 15/046; H01R 13/5205; H01B 7/02

(57) ABSTRACT

Provided is a waterproof structure for a multicore wire capable of enhancing waterproofness and reducing the number of components. The waterproof structure includes a multicore wire in which a plurality of core wires are housed in a sheath, a housing in which is housed a terminal fitting connected to a terminal portion of each core wire, and in which is formed an opening through which the multicore wire is externally extracted, and an elastic member having a tubular shape in which is formed a sheath insertion hole into which the sheath is inserted, disposed in the opening, and intimately contacting a circumferential surface of the opening and an outer circumferential surface of the sheath.

### CROSS-REFERENCE TO RELATED APPLICATIONS

This application is the U.S. national stage of PCT/JP2019/021504 filed on May 30, 2019, which claims priority of Japanese Patent Application No. JP 2018-114157 filed on Jun. 15, 2018, the contents of which are incorporated herein.

### TECHNICAL FIELD

The present disclosure relates to a waterproof structure for a multicore wire.

### BACKGROUND

Conventionally, structures for waterproofing a terminal portion of a multicore wire in which a plurality of core wires are enclosed with a sheath are known. For example, in the following JP 2016-184542A, a structure for waterproofing the inside of the sheath of a multicore wire using a heat shrinkable tube is described. At the terminal portion of a multicore wire, core wires are exposed from the sheath. The end portion of the sheath is covered with a heat shrinkable tube, and the shrunk heat shrinkable tube diameter-reduces the sheath and blocks gaps inside the sheath. Also, hot melt on the inner surface of the heat shrinkable tube melts and fills minute gaps inside the sheath. The inside of the sheath is thereby waterproofed.

A terminal fitting is connected to each core wire exposed from the sheath. The terminal fitting connected to each core wire is housed in a connector. The connector is generally waterproofed by individual rubber plugs fitted to the respective core wires. That is, the terminal portion of a multicore wire is waterproofed by a heat shrinkable tube and individual rubber plugs.

However, in order to further enhance the waterproofness of the inside of the sheath in a configuration such as the above, the minute gaps inside the sheath need to be completely filled. Since it is not easy to completely fill the gaps inside the sheath, enhancing the waterproofness is difficult. Also, with a configuration such as the above, there is a problem in that a heat shrinkable tube for waterproofing the sheath and individual rubber plugs for waterproofing the connector are needed, resulting in a large number of components.

The present disclosure has been accomplished based on circumstances such as the above, and an object thereof is to provide a waterproof structure for a multicore wire that is capable of enhancing waterproofness and reducing the number of components.

### SUMMARY

A waterproof structure for a multicore wire of the present disclosure includes a multicore wire in which a plurality of core wires are housed in a sheath, a housing in which is housed a terminal fitting connected to a terminal portion of each core wire, and in which is formed an opening through which the multicore wire is externally extracted, and an elastic member having a tubular shape in which is formed a sheath insertion hole into which the sheath is inserted, disposed in the opening, and intimately contacting a circumferential surface of the opening and an outer circumferential surface of the sheath. The elastic member is formed in advance and installed in the housing.

### Advantageous Effects of Disclosure

According to the present disclosure, an elastic member compressed between a housing and a sheath intimately contacts the outer circumferential surface of the sheath, thus enabling the inside of the sheath to be reliably waterproofed. Also, the elastic member waterproofs the opening of the housing, thus enabling the need for individual rubber plugs such as conventionally used to be obviated. Accordingly, waterproofness can be enhanced, and the number of components can be reduced.

### BRIEF DESCRIPTION OF DRAWINGS

FIG. 1 is a perspective view showing a waterproof structure for a multicore wire in Embodiment 1.

FIG. 2 is a cross-sectional view showing the waterproof structure for a multicore wire.

FIG. 3 is a cross-sectional view showing a waterproof structure for a multicore wire in Embodiment 2.

### DETAILED DESCRIPTION OF PREFERRED EMBODIMENTS

Preferred modes of the present disclosure will be illustrated below.

The waterproof structure for a multicore wire of the present disclosure may be configured such that core wire insertion holes into which the core wires are individually inserted are formed in the elastic member, and the circumferential surfaces of the core wire insertion holes individually intimately contact the outer circumferential surface of the core wires. According to such a configuration, waterproofness due to the elastic member can be further enhanced.

Also, the waterproof structure for a multicore wire of the present disclosure may be configured to include a fixing member that fixes the housing and the multicore wire. According to such a configuration, the housing and the sheath are held in a joined state by the fixing member, thus enabling the connector to be prevented from separating at the terminal portion of the multicore wire.

### Embodiment 1

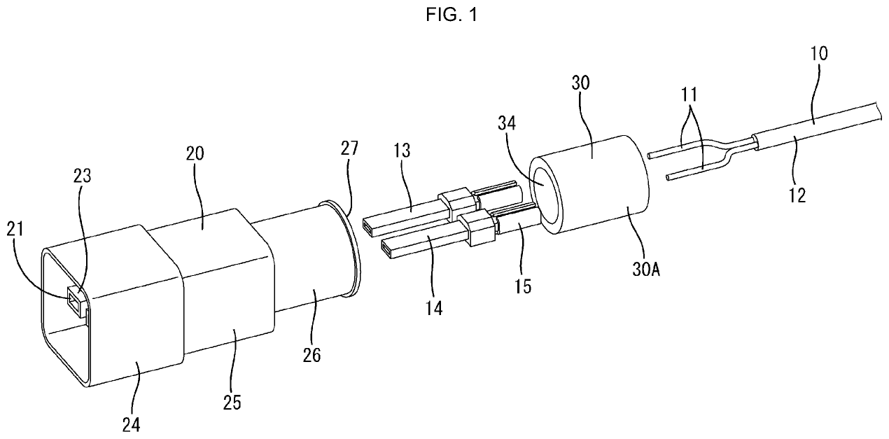

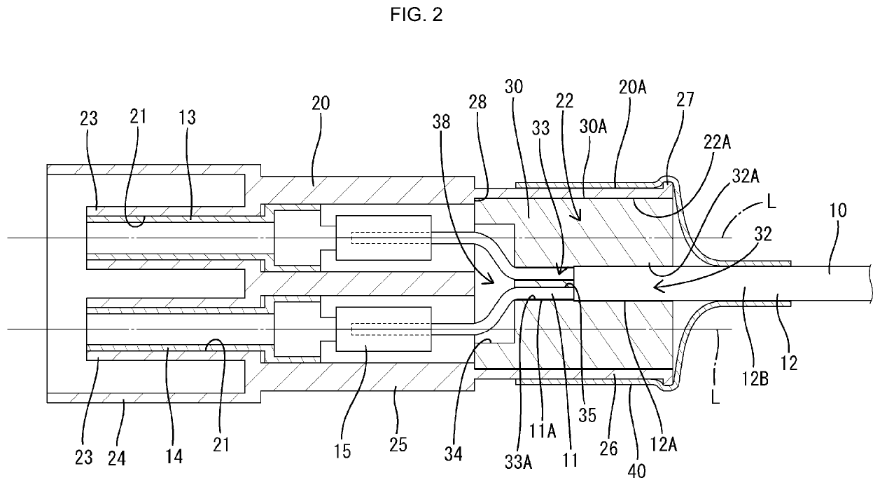

Hereinafter, Embodiment 1 embodying the present disclosure will be described in detail, with reference to FIGS. 1 and 2.

The waterproof structure for a multicore wire in the present embodiment is a structure that uses an elastic member 30 to waterproof the terminal portion of a multicore wire 10 in which a plurality (two in the present embodiment) of core wires 11 are integrated by being collectively enclosing with a sheath 12.

The sheath 12 is made of a thermoplastic resin (thermoplastic urethane, etc.), and insulates and protects the two core wires 11. The core wires 11 are covered wires, and, as shown in FIG. 1, a terminal fitting 13 is connected to the terminal portion of each core wire 11. The terminal fitting 13 is a female terminal fitting, and is provided with a tubular terminal main body 14 and a connecting part 15 that is connected to the terminal portion of the core wire 11. The terminal fitting 13 is electrically connected to an opposing male terminal fitting (not shown) by the male terminal fitting being inserted into the terminal main body 14. The connecting part 15 is connected by crimping to the terminal portion of the core wire 11. The terminal fitting 13 is inserted inside a housing 20 and retained by a lance or the like (not shown). Hereinafter, with each constituent member, the front side (left side in FIG. 1) in the insertion direction of the terminal fitting 13 into the housing 20 will be described as forward, and the opposite side thereto (right side in FIG. 1) will be described as rearward.

The housing 20 is made of a synthetic resin, and, as shown in FIG. 2, has formed therein terminal housing parts 21 in which the terminal fittings 13 connected to the terminal portion of the core wires 11 are housed, and an opening 22 through which the multicore wire 10 is externally extracted. The housing 20 constitutes a female connector in which the female terminal fittings 13 are housed.

Two terminal housing parts 21 corresponding to the number of the terminal fittings 13 are provided to be arranged side by side. Approximately the front half portion of each terminal housing part 21 is formed as a tower part 23. The tower part 23 is independently provided for every terminal housing part 21. The two tower parts 23 are collectively enclosed by a hood part 24. Approximately the back half portion of the terminal housing parts 21 is formed as a housing main body 25 having a block shape. The hood part 24 and the housing main body 25 have a rectangular cross-sectional outer shape.

The opening 22, as shown in FIG. 2, collectively opens rearward onto the rear side of the two terminal housing parts 21. A circumferential surface 22A of the opening 22 is a circular arc surface. The opening 22 is formed in a tubular part 26 having a cylindrical shape provided on the rear end portion of the housing 20 (refer to FIG. 1). The tubular part 26 protrudes rearward from the rear surface of the housing main body 25. The exposed core wires 11, the end portion of the sheath 12 and the elastic member 30 are housed inside the tubular part 26 (opening 22).

A protruding part 27 protruding approximately orthogonally to the front-rear direction is provided on the rear end of the tubular part 26. The protruding part 27 is continuous around the entire circumference of the rear end of the tubular part 26. The protruding part 27 is stepped with respect to an outer circumferential surface 20A of the tubular part 26, and protrudes one step outwardly from the outer circumferential surface 20A of the tubular part 26.

A positioning part 28 for positioning the elastic member 30 is provided inside the housing 20. The positioning part 28 is a surface formed in a position opposing a front end face of the elastic member 30 and approximately orthogonal to the front-rear direction. The positioning part 28 is formed at the boundary between the terminal housing parts 21 and the opening 22. The positioning part 28 has a stepped shape protruding one step inwardly from a circumferential surface 22A of the opening 22.

The elastic member 30 intimately contacting the circumferential surface 22A of the opening 22 and an outer circumferential surface 12A of the sheath 12 is fitted inside the housing 20. The elastic member 30 has a columnar shape that fits into the tubular part 26, and is, for example, formed using silicon or the like. The size of the elastic member 30 in the axial direction is configured to be equivalent to the size of the tubular part 26 in the front-rear direction. The outer diameter size of the elastic member 30 is configured to be uniform throughout the entire length thereof in the axial direction.

A plurality of lip parts (not shown) are provided in a protruding manner on an outer circumferential surface 30A of the elastic member 30. The lip parts elasticity collapse and intimately contact the circumferential surface 22A of the opening 22, enabling infiltration of moisture through gaps between the circumferential surface 22A of the opening 22 and the outer circumferential surface 30A of the elastic member 30 to be prevented.

A sheath insertion hole 32 into which the sheath 12 is inserted, core wire insertion holes 33 into which the core wires 11 are individually inserted, and a insertion hole 34 into which the two core wires 11 are collectively inserted are formed inside the elastic member 30. The sheath insertion hole 32, the core wire insertion holes 33 and the insertion hole 34 communicate with each other in the axial direction.

The sheath insertion hole 32 has a circular cross-sectional shape, and is formed in a region of approximately half of the rear side of the elastic member 30 in the front-rear direction. The diameter size of the sheath insertion hole 32 is configured to be approximately the same or smaller than the diameter size of the sheath 12. A plurality of lip parts (not shown) intimately contacting the outer circumferential surface 12A of the sheath 12 are formed on a circumferential surface 32A of the sheath insertion hole 32. The lip parts elasticity collapse and intimately contact the outer circumferential surface 12A of the sheath 12, enabling infiltration of moisture through gaps between the circumferential surface 32A of the sheath insertion hole 32 and the outer circumferential surface 12A of the sheath 12 to be prevented.

Two core wire insertion holes 33 are formed in correspondence with the number of core wires 11. The two core wire insertion holes 33 are arranged approximately parallel. Each core wire insertion hole 33 has a circular cross-sectional shape and is formed forward of the sheath insertion hole 32. The combined width size of the two parallel core wire insertion holes 33 is configured to be smaller than the diameter size of the sheath insertion hole 32. The portion between the parallel core wire insertion holes 33 serves as a stopper part 35 that restricts forward movement of the sheath 12.

A plurality of lip parts (not shown) intimately contacting an outer circumferential surface 11A of each core wire 11 are formed on the circumferential surface 33A of each core wire insertion hole 33. The lip parts elasticity collapse and individually intimately contact the outer circumferential surface 11A of the core wires 11, enabling infiltration of moisture through gaps between the circumferential surfaces 33A of the core wire insertion holes 33 and the outer circumferential surface 11A of the core wires 11 to be prevented.

The insertion hole 34 is of a size spanning the two core wire insertion holes 33, and is formed forward of the two core wire insertion holes 33. The insertion hole 34 is formed in the front end portion of the elastic member 30. The insertion hole 34 is of a size facing the center of each terminal housing part 21 in the width direction. In other words, as shown in FIG. 2, a central line L in the width direction of each terminal housing part 21 is located on the inner side of the insertion hole 34. The insertion hole 34 forms a branch space 38 in which the portions of the core wires 11 that extend forward from the core wire insertion hole 33 branch toward the respective terminal housing parts 21.

The waterproof structure for a multicore wire is provided with a fixing member 40 that fixes the housing 20 and the multicore wire 10. The fixing member 40 is a member such as tape wound from the outer circumferential surface 20A of the housing 20 to the outer circumferential surface 12A of the sheath 12 or a shrinkable tube covering from the outer circumferential surface 20A of the housing 20 to the outer circumferential surface 12A of the sheath 12. The fixing member 40 is disposed from the tubular part 26 of the housing 20 to an extension part 12B of the sheath 12 that extends rearward of the elastic member 30. The fixing member 40 intimately contacts or adheres to the outer circumferential surface 20A of the housing 20 and the outer circumferential surface 12A of the sheath 12. The fixing member 40 latches onto the protruding part 27, and is prevented from shifting forward or rearward.

Due to the fixing member 40, the housing 20 and the multicore wire 10 are securely joined. That is, due to the fixing member 40, the connector is prevented from separating at the terminal portion of the multicore wire 10. Also, due to the fixing member 40, tensile force acting on the multicore wire 10 is received by the housing 20, thus enabling the elastic member 30 to be prevented from separating from the housing 20.

Next, an example of a method for manufacturing the waterproof structure for a multicore wire of the present embodiment will be described.

First, the elastic member 30 is inserted onto the multicore wire 10 (refer to FIG. 1). The core wires 11 exposed at the terminal portion of the multicore wire 10 pass from the sheath insertion hole 32 of the elastic member 30 into the insertion hole 34 and are extracted forwardly (refer to FIG. 2). The end portion of the sheath 12 is passed into the sheath insertion hole 32, and is restricted from moving forward by the stopper part 35. The core wires 11 pass through the respective core wire insertion holes 33. The circumferential surface 32A of the sheath insertion hole 32 intimately contacts the outer circumferential surface 12A of the sheath 12, and the circumferential surface 33A of each core wire insertion hole 33 comes in intimate contact with the outer circumferential surface 11A of each core wire 11.

Subsequently, the terminal fittings 13 are crimped to the terminal portions of the respective core wires 11 that extend forward from the elastic member 30.

Next, the terminal fittings 13 are housed in the terminal housing parts 21 of the housing 20, and the elastic member 30 is fitted inside the tubular part 26. The terminal fittings 13 are retained by the lance upon reaching a regular position of the terminal housing parts 21. The elastic member 30 elasticity collapses (compresses) in the radial direction between the tubular part 26 and the sheath 12 when fitted into the tubular part 26. The outer circumferential surface 30A of the elastic member 30 intimately contacts the circumferential surface 22A of the opening 22. The circumferential surface 32A of the sheath insertion hole 32 intimately contacts the outer circumferential surface 12A of the sheath 12. The circumferential surface 33A of the core wire insertion holes 33 intimately contacts the outer circumferential surface 11A of the respective core wires 11. The end face of the sheath 12 and the opening 22 of the housing 20 are thus encapsulated and reliably sealed.

Manufacture of the waterproof structure for a multicore wire in the present embodiment is thereby completed.

Next, the operation and effects of the embodiment constituted as illustrated above will be described.

The waterproof structure for a multicore wire of the present embodiment is provided with a multicore wire 10, a housing 20, and an elastic member 30. The multicore wire 10 encloses a plurality of core wires 11 with a sheath 12. The housing 20 houses terminal fittings 13 connected to the terminal portion of the core wires 11, and an opening 22 through which the multicore wire 10 is externally extracted is formed therein. The elastic member 30 has a tubular shape in which a sheath insertion hole 32 into which the sheath 12 is inserted is formed, is disposed in the opening 22, and intimately contacts a circumferential surface 22A of the opening 22 and an outer circumferential surface 12A of the sheath 12. According to this configuration, the elastic member 30 compressed between the housing 20 and the sheath 12 intimately contacts the outer circumferential surface 12A of the sheath 12, thus enabling the inside of the sheath 12 to be reliably waterproofed. Also, the elastic member 30 waterproofs the opening 22 of the housing 20, thus enabling the need for individual rubber plugs such as conventionally used to be obviated. Accordingly, waterproofness can be enhanced, and the number of components can be reduced.

Also, core wire insertion holes 33 into which the core wires 11 are individually inserted are formed in the elastic member 30, and a circumferential surface 33A of the core wire insertion holes 33 individually intimately contacts the outer circumferential surface 11A of the respective core wires 11. According to this configuration, the waterproofness due to the elastic member 30 can be further enhanced.

Also, a fixing member 40 that fixes the housing 20 and the multicore wire 10 is provided. According to this configuration, the housing 20 and the sheath 12 are held in a joined state by the fixing member 40, thus enabling the connector to be prevented from separating at the terminal portion of the multicore wire 10.

### Embodiment 2

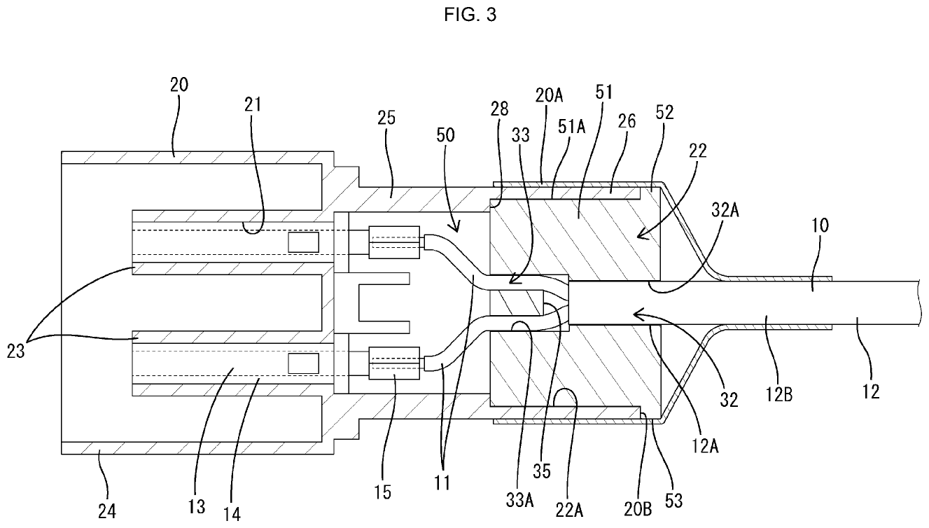

Next, a waterproof structure for a multicore wire according to Embodiment 2 that embodies the present disclosure will be described using FIG. 3.

The waterproof structure for a multicore wire of the present embodiment differs from Embodiment 1 in terms of a branch space 50 being formed inside the housing 20 rather than an elastic member 51. Note that the same reference signs are given to constituent elements that are similar to Embodiment 1, and redundant description will be omitted.

The waterproof structure for a multicore wire of the present embodiment is provided with a multicore wire 10, a housing 20, an elastic member 51 and a fixing member 40, similarly to Embodiment 1. The elastic member 51 has a columnar shape in which a sheath insertion hole 32 and core wire insertion holes 33 are formed, is disposed in an opening 22, and intimately contacts a circumferential surface 22A of the opening 22 and an outer circumferential surface 12A of the sheath 12, similarly to Embodiment 1. The sheath insertion hole 32 is formed in a region of approximately half of the rear side of the elastic member 51 in the front-rear direction, and the core wire insertion holes 33 are formed in a region of approximately half of the front side of the elastic member 51 in the front-rear direction.

A plurality of lip parts (not shown) are provided on an outer circumferential surface 51A of the elastic member 51, a plurality of lip parts (not shown) are provided on a circumferential surface 32A of the sheath insertion hole 32, and a plurality of lip parts (not shown) are provided on a circumferential surface 33A of the core wire insertion holes 33.

A flange part 52 protruding approximately orthogonally to the front-rear direction is provided on the rear end of the elastic member 51. The flange part 52 is continuous around the entire circumference of the rear end of the elastic member 51. The flange part 52 is stepped with respect to the outer circumferential surface 51A of the elastic member 51, and protrudes one step outwardly from the outer circumferential surface 51A of the elastic member 51. An outer circumferential surface 53 of the flange part 52 is flush with an outer circumferential surface 20A of the housing 20. The flange part 52 intimately contacts a rear surface 20B of the housing 20 around the entire circumference of the tubular part 26.

The core wire insertion holes 33 open in the front face of the elastic member 51, and face into the interior space of the housing 20. The interior space of the housing 20 forms the branch space 50 in which portions of the core wires 11 that extend forward branch toward the respective terminal housing parts 21 from the elastic member 51. The branch space 50 is of a size spanning the two terminal housing parts 21, and is continuous with the two terminal housing parts 21.

As described above, the waterproof structure for a multicore wire of the present embodiment is provided with a multicore wire 10, a housing 20, and an elastic member 51, similarly to Embodiment 1, with the elastic member 51 compressed between the housing 20 and a sheath 12 intimately contacting an outer circumferential surface 12A of the sheath 12, thus enabling the inside of the sheath 12 to be reliably waterproofed, and the elastic member 51 waterproofing an opening 22 of the housing 20, thus enabling the need for individual rubber plugs such as conventionally used to be obviated. Accordingly, waterproofness can be enhanced, and the number of components can be reduced.

### OTHER EMBODIMENTS

The present disclosure is not limited to the embodiments illustrated in the description and drawings, and embodiments such as the following, for example, are also included in the technical scope of the disclosure.

In the above embodiments, the core wire insertion holes 33 are formed in the elastic member 30 (51), but in order to waterproof the inside of the sheath 12 and the inside of the housing 20, at least the sheath insertion hole 32 need only be formed, and the core wire insertion holes 33 need not necessarily be formed.

In the above embodiments, the fixing member 40 that fixes the housing 20 and the multicore wire 10 is provided, but the fixing member 40 need not necessarily be provided.

In the above embodiments, the elastic member 30 (51) is prevented from separating by the fixing member 40, but the present disclosure is not limited thereto, and a holder that blocks the rear side of an elastic member may be provided, for example.

In the above embodiments, the case where the present disclosure is applied to a female connector was illustrated, but the present disclosure is not limited thereto, and can also be applied to a male connector.

In the above Embodiment 1, the protruding part 27 is provided on the rear end of the housing 20, but the present disclosure is not limited thereto, and the position of the protruding part 27 in the front-rear direction may be changed, and may, for example, be located forward of the rear end of the housing 20.

In the above Embodiment 1, the protruding part 27 spans the entire circumference of the tubular part 26, but the present disclosure is not limited thereto, and the protruding part 27 may be partially provided around the circumference of the tubular part 26.

1. A waterproof structure for a multicore wire, comprising:
a multicore wire in which a plurality of core wires are housed in a sheath;
a housing in which is housed a terminal fitting connected to a terminal portion of each core wire, and in which is formed an opening through which the multicore wire is externally extracted; and
an elastic member having a tubular shape in which is formed a sheath insertion hole into which the sheath is inserted, disposed in the opening, and intimately contacting a circumferential surface of the opening and an outer circumferential surface of the sheath,
wherein the elastic member is formed in advance and installed in the housing.

2. The waterproof structure for a multicore wire according to claim 1, wherein core wire insertion holes into which the core wires are individually inserted are formed in the elastic member, and a circumferential surface of the core wire insertion holes individually intimately contact an outer circumferential surface of the core wires.

3. The waterproof structure for a multicore wire according to claim 1, further comprising:
a fixing member fixing the housing and the multicore wire.

4. The waterproof structure according to claim 3, wherein core wire insertion holes into which the core wires are individually inserted are formed in the elastic member, and a circumferential surface of the core wire insertion holes individually intimately contact an outer circumferential surface of the core wires.
